(19) United States
(12) Patent Application Publication
(10) Pub. No.: US 2021/0298242 A1
(43) Pub. Date: Sep. 30, 2021

(54) IMPROVED BRANCH CUTTER

(71) Applicant: GREY TECHNOLOGY LIMITED, Warndon, Worcestershire (GB)

(72) Inventors: NICHOLAS GERALD GREY, WARNDON, WORCESTERSHIRE (GB); CHRISTOPHER VAGGES, WARNDON, WORCESTERSHIRE (GB)

(21) Appl. No.: 16/330,709

(22) PCT Filed: Sep. 7, 2017
(86) PCT No.: PCT/GB2017/052604

§ 371 Date: Mar. 5, 2019

(30) Foreign Application Priority Data
Sep. 8, 2016 (GB) 1615290.2

(51) Int. Cl. A01G 3/08; B27B 9/00

(52) U.S. Cl. CPC A01G 3/088; B27B 9/00

(57) ABSTRACT

The invention relates to a branch cutter (10), namely a motor-powered tool having a circular saw blade used for cutting tree branches and the like. The periphery of the saw blade is at least partially covered by a protective housing (24), the housing having a first opening (52) to expose a first portion of the periphery of the saw blade, and a second opening (54) to expose a second portion of the periphery of the saw blade. The provision of two housing openings exposing two portions of the periphery of the saw blade increases the utility and ease of use of the branch cutter.

### FIELD OF THE INVENTION

The invention relates to a branch cutter, namely a powered tool having a circular saw blade used for cutting tree branches and the like.

For brevity, reference is made below to the user of the branch cutter being male but that is not necessarily the case in practice.

### BACKGROUND TO THE INVENTION

It is known to cut tree branches manually with a conventional saw. It is also known to cut branches with a chain saw, the chain carrying cutting teeth and being driven by an internal combustion engine or by an electric motor.

Another type of branch cutter, and the type to which the present invention is directed, has a substantially rigid circular saw blade with saw teeth around its periphery, the saw blade being driven to rotate, typically by an electric motor. A known branch cutter of this type is supplied by the present Applicant under the model designation HT04, the blade of that particular branch cutter being driven by an electric motor which is powered by a battery mounted on the handle of the tool.

Branch cutters of this type partially enclose at least one side of the saw blade in a housing, the housing extending around a part of the periphery of the saw so that the saw blade is fully exposed only at a housing opening. The provision of a housing around a large proportion of the periphery of the blade significantly reduces the likelihood of inadvertent contact with the saw blade, particularly with the saw teeth.

The size of the housing opening, namely its radial and circumferential extent, is largely determined by the radius of the blade. The blade is mounted upon a bearing at its centre and the maximum thickness of a branch which can theoretically be cut is therefore slightly less than the radius of the blade. However, the housing of the known branch cutters extends beyond the bearing so as to provide protection for the bearing. The exposed radial extent of the saw blade is therefore less than the blade radius, which thereby reduces the thickness of a branch which can be cut. In particular, whilst the blade might have a radius of 50 mm the housing opening may expose only the outer part of the blade (having a radial extent of around 25 mm for example). Such a branch cutter therefore has a maximum cutting depth of 25 mm.

It is desirable for the housing to cover the blade bearing so that the bearing can be protected from damage which might otherwise be caused by contacting a branch being cut, or contacting neighbouring branches during a cutting operation. Also, by covering the bearing the likelihood of sawdust, sap and the like fouling the bearing is reduced. Furthermore, the saw blade is typically removable for cleaning and replacement and is secured to the bearing by a fastening; it is desirable that a branch being cut does not engage the fastening so as to reduce the likelihood that the blade might inadvertently become loosened or released whilst it is rotating.

The torque of the motor driving the saw blade can be determined according to the maximum thickness of a branch which can be cut. For example, if the housing opening is sized to permit a maximum branch thickness of around 25 mm to be cut, the motor torque can be chosen accordingly and the requirement to provide sufficient torque to cut through thicker branches can be avoided. Reducing the maximum torque required by the motor is particularly beneficial for battery-powered branch cutters.

The known branch cutter HT04 uses a peripheral pinion gear to drive the saw blade. The saw blade is therefore mounted to a bearing at its centre but is driven to rotate at its periphery. This has significant benefits in terms of packaging as it is not necessary to communicate the drive from the periphery to the centre of a (rotatable) saw blade. The housing can therefore have a reduced thickness, particularly adjacent to the centre of the saw blade, which reduces the likelihood that the housing will foul another branch (or another part of the branch being cut) during use. The peripheral pinion gear of the HT04 branch cutter also facilitates the removal and refitting of the saw blade.

It will be understood that a branch cutter having a housing opening with a radial extent of 25 mm can be used to cut through branches which are thicker than 25 mm. In particular, it will be possible with such a branch cutter to cut through 25 mm of a 30 mm branch and break the remaining 5 mm (for example). Also, it is possible to cut through 25 mm of a 50 mm branch from one side of the branch and then to cut through the remaining 25 mm from the other side of the branch. The ability to re-orient the branch cutter so as to be able to cut a branch from both sides is not always possible, however, and the maximum thickness of branch which can be cut may in practice be determined directly by the size of the housing opening.

The circumferential extent of the housing opening will typically exceed the radial extent, notwithstanding that it is desirable to restrict the circumferential extent of the housing opening is so as to minimise the risk of inadvertent contact with the teeth of a rotating saw blade.

### SUMMARY OF THE INVENTION

The present invention relates to an improved branch cutter, and in particular to a branch cutter which can more readily be used safely to cut branches of greater thickness without requiring a larger blade or a more powerful motor.

According to the present invention there is provided a branch cutter having a circular saw blade and a motor to drive the saw blade to rotate, the periphery of the saw blade being at least partially covered by a protective housing, the housing having a first opening to expose a first portion of the periphery of the saw blade, the housing having a second opening to expose a second portion of the periphery of the saw blade.

The first portion of the periphery of the saw blade and the second portion of the periphery of the saw blade are spaced apart around the circumference of the saw blade. This permits the branch cutter to be used to cut a branch in a first direction by way of the saw teeth exposed at the first opening, and in a second direction by way of the saw teeth exposed at the second opening, without substantially re-orienting the branch cutter. The branch cutter can therefore be used, for example, to cut the top half of a branch in a downwards direction and the bottom half of the same branch in an upwards direction, without substantially re-orienting the branch cutter. If each of the first and second openings exposes a radial extent of 25 mm of the blade, the maximum branch thickness which can readily be cut is 50 mm.

The references to the branch cutter not being re-oriented are significant in practice, often in terms of safety of use of the branch cutter. As above explained, it is possible to cut thicker branches with the known branch cutters, but only by re-orienting the branch cutter, namely directing the branch cutter towards the branch from one side and then from another side (or from the top and then the bottom, for example). If the branch cutter is being used to cut a branch some distance from the ground the user may have to climb down a ladder, reposition the ladder and then re-climb the ladder in order to gain safe access to opposing sides of the branch. If it is not possible to re-position the ladder, or the user is not sufficiently diligent to do this, the first side of the branch may be cut with the housing opening (and the exposed rotating saw teeth) facing away from the user and the user pushing the blade away from himself as the branch is cut. The second side of the branch may then be cut with the housing opening (and the exposed rotating saw teeth) facing towards the user and being pulled towards the user as the branch is cut. The latter part of this operation clearly carries significant danger to the user.

Alternatively, the user may choose to cut through around half of a thick branch from above, moving the blade downwardly as that half of the branch is cut. The second half of the branch can then be cut from below, moving the blade upwardly as the branch is cut. Whilst such a cutting operation is possible with the known branch cutters, it either requires the user to re-position himself, or to re-position his hands upon the handle of the branch cutter. In practice, the user may have to reverse his right and left hands upon the handle of the branch cutter, and this might significantly reduce the safety and comfort of the user.

For the above reasons, in practice the known branch cutters are typically used to cut branches in a single orientation, and without the user having to re-orient himself or the branch cutter. The maximum thickness of branch which can be cut is therefore limited to approximately the radial extent of the housing opening (which might be 25 mm for example).

With the present invention on the other hand, the user can move the first portion of the saw blade into engagement with a branch, with the branch cutter being moved in a chosen and safe direction relative to the user. The user can maintain that chosen and safe direction of movement as a first part of the branch is cut. The user can thereafter move the second portion of the blade into engagement with a different part of the branch, again in a chosen and safe direction relative to the user (albeit a somewhat different direction). The user typically does not himself have to move between these cutting operations, and typically does not need to change his grip upon the branch cutter between these cutting operations. Enabling the branch to be cut from two different directions (or alternatively stated enabling different parts of the same branch to be cut sequentially) allows thicker branches to be cut, easily and safely, than is possible with the known branch cutters.

Preferably, a part of the first portion and a part of the second portion are diametrically opposed across the saw blade. This permits opposing sides of a branch to be cut in turn, thereby maximising the thickness of branch which can be cut.

It will be understood that diametrically opposing first and second openings are preferred as that will more easily permit the user to cut through a thick branch from two opposing directions. Precise diametric opposition is not, however, required, and having only a part of the first opening diametrically opposed to only a part of the second opening is sufficient.

Desirably, the centre of the saw blade is offset from the longitudinal axis of the cutter head. The cutter head contains the motor and the drive means for the blade and includes the housing for the blade. The known branch cutter HT04 has the centre of the saw blade, and the saw blade opening, aligned with the longitudinal axis of the cutter head. Such positioning of the opening is preferable as this allows the user to push the branch cutter towards the branch to be cut, with the force being directed along the longitudinal axis of the handle and cutter head to the cutting location. Providing a second opening with such an arrangement would either require the two openings to be very close together, or to require the existing opening to be moved to a less suitable position. Offsetting the centre of the saw blade from the longitudinal axis of the cutter head, however, allows the first opening to be aligned with the longitudinal axis of the cutter head as desired, with the second opening spaced a significant distance therefrom (and perhaps diametrically opposed thereto).

Desirably, the circumferential extent of the first opening and the circumferential extent of the second opening are identical or substantially identical. Desirably also, the radial extent of the first opening and the radial extent of the second opening are identical or substantially identical. Preferably, the shape and size of the first and second openings are identical or substantially identical. Providing a first opening and a second opening which are identical in size and shape enables effectively the same cutting operations to be undertaken by way of both openings.

Alternatively, the first opening is larger in circumferential and/or radial extent than the second opening. Such an arrangement allows the first opening to be the primary opening which is used most of the time, with the second opening only being used occasionally, for example when required for cutting thicker branches.

Preferably, the branch cutter has a handle and the second opening is closer to the handle than is the first opening. It will be understood that the user will typically be able to impart greater force upon the saw blade when exposed through an opening closer to the handle; locating the second opening closer to the handle than the first opening will likely encourage the user to utilise the second opening most of the time, particularly when cutting higher branches. It will be understood that when using a branch cutter such as HT04 the position of the saw blade opening requires the user to cut a branch by pushing the cutter head away from himself. This is typically the safest option, but is disadvantageous when cutting a branch from below as the weight of the branch will seek to close the cut and clamp the saw blade. Locating the second opening closer to the cutter head allows a branch to be cut by pulling the cutter head towards the user, which in particular allows the cutting of a high branch from above so that the weight of the branch acts to open up the cut (and not to clamp the blade).

The first and second housing openings have leading and trailing edges according to the direction of rotation of the saw blade. It will be understood that the rotation of the saw blade in use will drive the branch being cut away from the leading edge and towards the trailing edge (and/or may move the branch cutter relative to the branch). Desirably the trailing edge has a larger radial extent than the leading edge. The leading edge is primarily provided to cover the saw blade and so does not require a large radial extent beyond the blade. The trailing edge should have a greater radial extent, however, i.e. it should extend farther beyond the saw blade so as to trap a branch against the trailing edge as the saw blade rotates (thereby minimising the likelihood that the branch is pushed away from the saw blade by engagement with the trailing edge). Desirably, the trailing edge can carry teeth or other formations, and/or can be shaped, to hold the branch in engagement with the rotating saw blade, or to urge the branch towards the rotating saw blade.

Desirably, the saw blade is driven to rotate by a gear wheel or pinion engaging its periphery. There is therefore no requirement to communicate drive to the centre of the saw blade and the central mounting of the saw blade can be separated from the peripheral drive.

Preferably the pinion is driven by a flexible belt. Whilst flexible drive belts are designed to be substantially inextensible, the belt provides some shock absorption between the saw blade and the motor, and thereby reduces the likelihood of damage to the saw teeth by the pinion during use.

Desirably, the housing covers only parts of one side of the saw blade, so that the other side of the saw blade is fully or largely exposed. It is therefore appreciated that the safety of the user is enhanced by the housing covering the periphery of the saw blade and the saw teeth; there is little or no additional safety provided by covering the flat side of the blade. Also, fully or largely exposing one side of the saw blade better allows sawdust and other debris to move away from the saw blade rather than becoming trapped by a part of the branch cutter.

Preferably, the branch cutter has a bearing for the saw blade and a fastener for securing the saw blade to the bearing. Preferably also, the fastener is inserted from the exposed side of the saw blade towards the covered side of the saw blade. Such an arrangement facilitates access to the fastener, for example when it is desired to remove the saw blade for cleaning, sharpening and/or replacement. Such an arrangement also allows the bearing to be obscured and protected by the housing.

Branch cutters are known to require frequent cleaning due to the combination of sap, moisture and sawdust which will often accumulate upon and within the branch cutter. The provision of a peripheral drive is particularly beneficial in this respect as the saw blade can be secured to the bearing by way of a simple removable fastening, permitting regular and repeated removal for cleaning of the saw blade and housing.

### BRIEF DESCRIPTION OF THE PREFERRED EMBODIMENTS

The invention will now be described in more detail, by way of example, with reference to the accompanying drawings, in which:

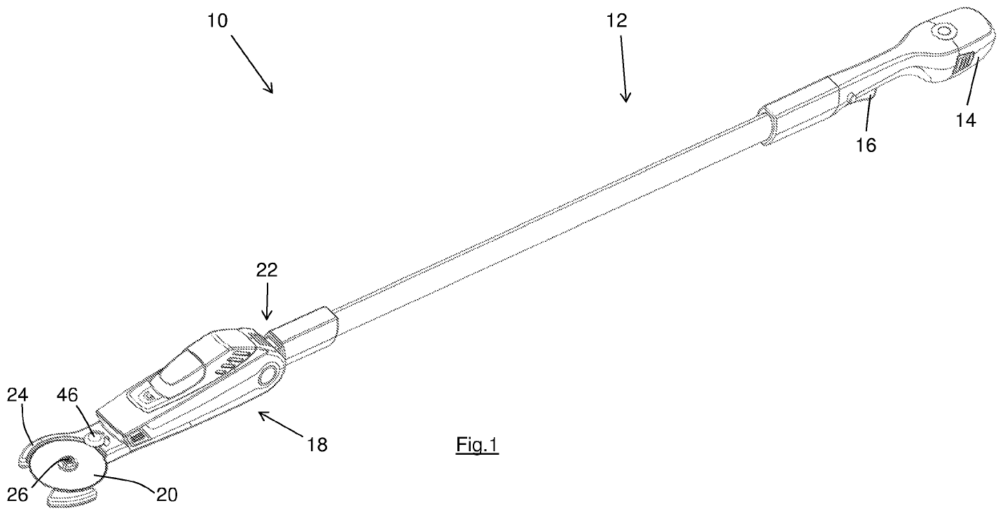

FIG. 1 is a perspective view of a branch cutter according to the present invention;

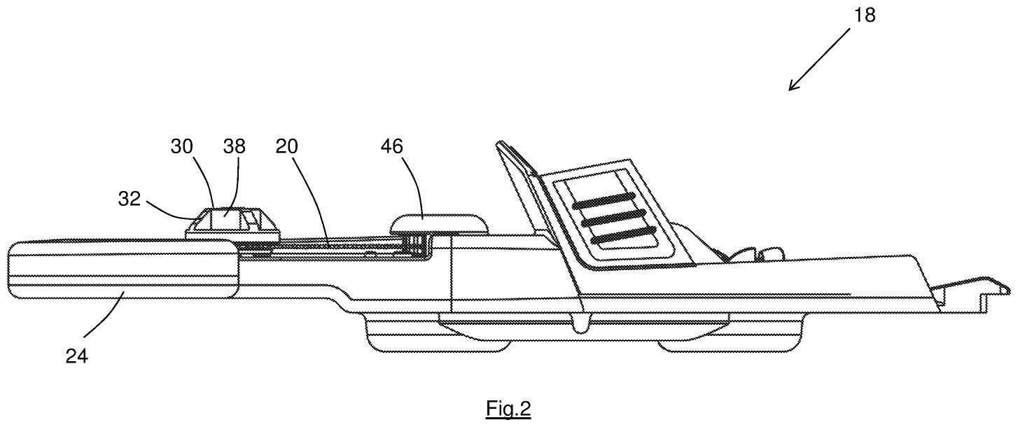

FIG. 2 is a side view of a part of the branch cutter;

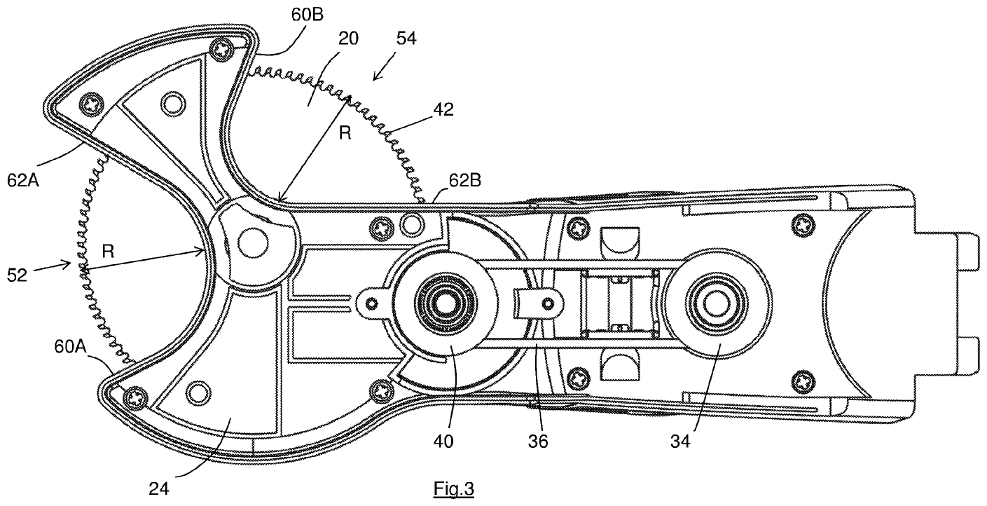

FIG. 3 is an underside view of the part of the branch cutter of FIG. 2, with a part of the cover removed; and

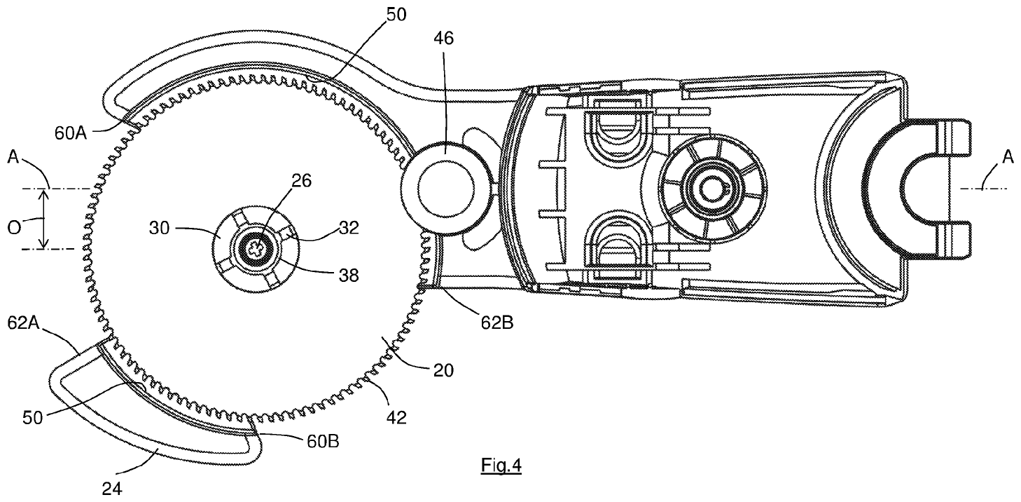

FIG. 4 is a top plan view of the part of the branch cutter of FIG. 3.

### DETAILED DESCRIPTION

The branch cutter 10 comprises a handle 12 having a (removable and rechargeable) battery 14 and an actuating switch 16. The battery and switch are connected to a motor (not seen) within the cutter head 18. The motor drives a circular saw blade 20 to rotate, as explained below.

In this embodiment the cutter head 18 is removable from the handle 12, by way of a releasable connection 22. The same handle 12 can therefore be used with other tools, including a hedge trimmer for example. In other embodiments a releasable connection is not required and the cutter head 18 is permanently secured to the handle 12.

The saw blade 20 is mounted to a bearing (not seen) at its centre by way of a releasable fastener 26. As better seen in FIG. 4 the fastener 26 is a cross-headed bolt which clamps a boss 30 against the surface of the saw blade 20, the saw blade having a small hole (not seen) at its centre through which the fastener 26 can pass. In this embodiment the hole is circular and is only slightly larger than the diameter of the shaft of the fastener 26 so that the insertion of the fastener serves to position the blade 20 centrally relative to its bearing (not seen); in other embodiments the hole is larger and accommodates a locating projection on the underside of the boss 30.

The boss 30 has four buttresses 32 which can be gripped by the user when the fastener 26 is being tightened and/or loosened, so as to hold the saw blade 20 against rotation during removal and fitment.

As seen in FIG. 2, the head of the fastener lies inside the sleeve 38 of the boss 30. The boss 30 therefore also protects the fastener 26 during use by reducing the likelihood that a branch being cut, or a neighbouring branch, or flying sawdust, will engage the fastener 26. The likelihood of the fastener 26 becoming unintentionally loosened is thereby much reduced. As with the known branch cutters and similar tools, the saw blade 20 rotates in a direction (counter-clockwise as viewed in FIG. 4) which acts to tighten the fastener 26.

As shown in relation to FIG. 3, the motor is connected to a drive pulley 34 which drives a flexible belt 36, the flexible belt in turn rotating a driven pulley 40 which is connected to a pinion (not seen) which engages the saw teeth 42 at the periphery of the saw blade 20. The pinion is located underneath a (non-rotating) cover 46 which is visible in FIGS. 1,2 and 4. It will be understood that the pinion has teeth which cooperate with the saw teeth 42, the pinon teeth ideally being shaped to maximise the area of engagement with the saw teeth 42 so as to minimise the point loading and thereby the wear upon the saw teeth.

Whilst the flexible belt 36 is designed to be substantially inflexible, in practice it will have some resilience and will therefore be able to absorb some of the stresses between the pinion and the saw teeth 42 and thereby reduce the maximum forces therebetween, so as to reduce the likelihood of damage to the pinion and/or saw teeth 42 in use.

The cutter head 18 has a housing 24 for the saw blade 20. It will be seen from FIGS. 3 and 4 that the housing 24 covers a part of only one side of the saw blade 20, so that the boss 30 and fastener 26 are permanently exposed and permanently accessible. Exposing one side of the saw blade 20 allows sawdust and the like to move away from the blade and thereby reduces the number of places at which sawdust, sap and other debris can become trapped (and compressed) within the cutter head 18.

The housing 24 extends beyond certain parts of the saw blade 20 and the extended parts are stepped around the periphery of the saw blade 20 so as to provide surfaces 50 which overlie and partially surround the saw teeth 42. The housing 24 thereby prevents inadvertent contact with the saw teeth. Accordingly, as seen in FIG. 2 in particular, the housing 24 covers a large proportion of the saw teeth 42.

The saw teeth 42 are, however, exposed at a first housing opening 52 and at a second housing opening 54. Thus, unlike the known branch cutters the saw blade 20 of the present branch cutter is exposed at two separate housing openings, providing two separate cutting regions. The first and second housing openings 52, 54 in this embodiment have the same radial extent R and the same peripheral extent (i.e. the circumferential distance between the leading edge 60A and trailing edge 62A of the first opening 52 is the same as the circumferential distance between the leading edge 60B and trailing edge 62B of the second opening 54), but this is not necessarily the case.

In practice, it is expected that for most of the time the branch cutter 10 will be used to cut branches which are smaller than the radial extent R, and the user will typically cut those branches by way of the saw teeth 42 exposed at the first housing opening 52, with the user pushing the cutter head 18 away from himself in common with the prior art branch cutter HT04. When it is desired to cut branches which are thicker than the radial extent R, or when it is desired to cut high branches from below, the user will typically use the saw teeth exposed at the second housing opening 54.

Typically, when using the saw teeth exposed at the second housing opening 54, the user will hold the branch cutter 10 with the second opening 54 facing downwardly and towards the user; the branch can then be cut by moving the cutter head 18 downwardly and slightly towards the user. If the branch is thicker than the radial extent R the user can (previously or subsequently) reposition the cutter head to cut through another part of the branch by way of the saw teeth exposed at the first opening 52, the cutter head being moved away from the user (and perhaps also slightly upwardly) as the branch is cut. It will be understood that the user does not have to reposition himself, or to reposition the branch cutter in his hands, in order to undertake both of these cutting operations.

It will be seen that the second opening 54 is not diametrically opposed to the first opening 54, though in other embodiments the openings could be diametrically opposed if desired. However, a part of the second opening 54 is diametrically opposed to a part of the first opening 52, so that the two openings can be used to cut a branch in two substantially opposing directions. It will be understood that a part of the first and second openings being diametrically opposed means that the ends of a chosen diameter of the saw blade lie in the respective first and second openings.

The diametrical opposition of parts of the openings 52,54 is achieved by offsetting the centre of the blade from the longitudinal axis A-A (FIG. 4), in this embodiment by an offset O. The offsetting enables the desired separation of the first and second openings whilst still having the first opening spanning the longitudinal axis A-A. This positioning of the first opening is highly desirable as it allows the user to push the blade 20 against a branch to be cut with the line of force acting directly along the longitudinal axis A-A (and consequently along the longitudinal axis of the handle 12 in this embodiment).

The direction of blade rotation in the orientation of FIG. 4 is anti-clockwise. During use the branch is driven away from the leading edge 60A (or 60B as applicable) and towards the trailing edge 62A (or 62B as applicable). The trailing edges 62A,B have a greater radial extent that the leading edges 60A,B so as to reduce the likelihood that a branch is forced over the trailing edge and away from the saw teeth 42. In other embodiments the trailing edges 62A,B can carry fixed teeth or be roughened so as to reduce the likelihood that a branch will move away from the saw teeth 42 during cutting.

1. A branch cutter (10) having a circular saw blade (20) and a motor to drive the saw blade to rotate, the periphery of the saw blade being at least partially covered by a housing (24), the housing having a first opening (52) to expose a first portion of the periphery of the saw blade, the housing having a second opening (54) to expose a second portion of the periphery of the saw blade.

2. The branch cutter according to claim 1 in which the first opening (52) and the second opening (54) are spaced apart around the circumference of the saw blade.

3. The branch cutter according to claim 1 which the first opening (52) and the second opening (54) are located so that a part of the first portion of the saw blade and a part of the second portion of the saw blade are diametrically opposed.

4. The branch cutter according to claim 1 having a cutter head (18) on which the saw blade (20) is mounted, the cutter head housing the motor and having a longitudinal axis (A-A), the centre of the saw blade (20) being offset (O) from the longitudinal axis (A-A).

5. The branch cutter according to claim 1 in which the circumferential extent of the first opening (52) and the circumferential extent of the second opening (54) are substantially identical.

6. The branch cutter according to claim 1 in which the radial extent (R) of the first opening and the radial extent of the second opening are substantially identical.

7. The branch cutter according to claim 1 in which the shape and size of the first and second openings (52, 54) are substantially identical.

8. The branch cutter according to claim 1 having an operating handle (12), in which the second opening (54) is closer to the operating handle (12) than the first opening (52).

9. The branch cutter according to claim 8 in which the operating handle (12) has a longitudinal axis, and in which the first opening (52) spans the longitudinal axis of the handle.

10. The branch cutter according to claim 1 in which the first opening (52) has a leading edge (60A) and trailing edge (62A), and in which the trailing edge of the first opening projects beyond the saw blade (20) further than the leading edge of the first opening.

11. The branch cutter according to claim 1 in which the second opening (54) has a leading edge (60B) and trailing edge (62B), and in which the trailing edge of the second opening projects beyond the saw blade (20) further than the leading edge of the second opening.

12. The branch cutter according to claim 10 in which the trailing edge (62A) of the first opening (54) and/or the trailing edge (62B) of the second opening (54) carries teeth or other formations adapted to hold a branch in engagement with the rotating saw blade in use.

13. The branch cutter according to claim 1 in which the saw blade (20) is driven to rotate by a pinion engaging its saw teeth (42).

14. The branch cutter according to claim 13 in which the pinion is connected to the motor by way of a flexible drive belt (36).

15. The branch cutter according to claim 1 in which the housing (24) covers parts of one side of the saw blade (20), the other side of the saw blade being largely exposed.

16. The branch cutter according to claim 15 having a bearing for the saw blade (20), the saw blade being removable and replaceable, the branch cutter having a removable fastener (26) for securing the saw blade (20) to the bearing, the fastener being fitted from the largely exposed side of the saw blade.

17. The branch cutter according to claim 16 in which the fastener (26) is located in a boss (30) which surrounds the fitted fastener.

18. The branch cutter according to claim 17 in which the boss has at least one buttress (32).

19. A branch cutter (10) having a cutter head (18) upon which a circular saw blade (20) is mounted, a motor housed by the cutter head and connected to the saw blade to drive the saw blade to rotate in use, the periphery of the saw blade being at least partially covered by a housing (24), the housing having a first opening (52) to expose a first portion of the periphery of the saw blade, the housing having a second opening (54) to expose a second portion of the periphery of the saw blade, the cutter head having a longitudinal axis (A-A), the centre of the saw blade (20) having a fixed offset (O) from the longitudinal axis (A-A), the first opening (52) having a leading edge (60A) and a trailing edge (62A), the trailing edge of the first opening projecting beyond the saw blade (20) further than the leading edge of the first opening, the second opening (54) having a leading edge (60B) and a trailing edge (62B), the trailing edge of the second opening projecting beyond the saw blade (20) further than the leading edge of the second opening, the branch cutter having an operating handle (12), the second opening (54) being closer to the operating handle (12) than the first opening (52).
